(19) United States
(12) Patent Application Publication
(10) Pub. No.: US 2020/0406406 A1
(43) Pub. Date: Dec. 31, 2020

(54) ELECTRICAL CONNECTION ELEMENT

(71) Applicant: STÄUBLI ELECTRICAL CONNECTORS AG, Allschwill (CH)

(72) Inventors: Alexander HEILMANN, Hemhofen (DE); Alexander HORNUNG, Eichstätt (DE)

(73) Assignee: STÄUBLI ELECTRICAL CONNECTORS AG, Allschwil (CH)

(21) Appl. No.: 16/620,135

(22) PCT Filed: May 16, 2018
(86) PCT No.: PCT/EP2018/062738

§ 371 Date: Dec. 6, 2019

(30) Foreign Application Priority Data
Jun. 8, 2017 (EP) 17174970.8

(51) Int. Cl. B23K 37/02; H01R 13/426; H01R 31/06

(52) U.S. Cl. CPC B23K 37/0258; H01R 13/17; H01R 31/06; H01R 13/426

(57) ABSTRACT

The invention relates to an electric connection assembly (1), in particular a secondary circuit welding connection assembly, which is used to provide an electric contact between an electrode-side connection point (2) of an electrode (3) and a supply-side connection point (4) of a supply point (5) of a welding device (S). The connection assembly (1) comprises a current conductor (6) with a first contact section (7) arranged at one end for connecting to the electrode-side connection point (2) and a second contact section (8) at the end opposite the first contact section (7) for connecting to the supply-side connection point (4). The first contact section (7) together with the electrode-side connection point (2) and the second contact section (8) together with the supply-side connection point (4) are in the form of a socket-plug connection (20, 21) and can be plugged together along a plug-in axis (A).

### TECHNICAL FIELD

The present invention relates to an electrical connection element for the transmission of high currents, in particular for application in a welding appliance according to the preamble of claim 1.

### STATE OF THE ART

Secondary-circuit welding connector arrangements in connection with welding devices have become known from the state of the art. Typically, such secondary-circuit welding connector arrangements, which are also designated as current hat, are connected to the welding appliance in electrically conducting manner by screw-type terminals or screws. But screw-type terminals or screws have various disadvantages. On the one hand, the interchanging of the secondary-circuit welding connectors is very elaborate. On the other hand, they are not maintenance-free, and wear occurs in the course of interchanging the secondary-circuit welding connectors. Moreover, mounting by screw-type terminals or screws can have the result that the secondary-circuit joint is not optimally aligned and therefore an increased mechanical loading on the component arises, as a result of which a product failure is accelerated. The secondary-circuit welding connectors are often connected by means of metallically conductive contact pieces, in order to span the geometrical conditions prevailing in the given case. On the one hand, these contact pieces are very cost-intensive in their production; on the other hand, they result in an increased weight which has a negative effect on the efficiency of the overall arrangement of the welding unit.

### SUMMARY OF THE INVENTION

Proceeding from this state of the art, an object underlying the invention is to specify an electrical connection arrangement that overcomes the disadvantages of the state of the art. In particular, it is a preferred object to specify a connection arrangement that is easier to connect to the welding appliance, in particular and preferably with the proviso that the connection exhibits electrical contact properties that are as good as possible.

This object is achieved by the subject-matter of claim 1. According to this claim, an electrical connection arrangement, in particular a secondary-circuit welding connector arrangement, is specified for providing an electrical contact between an electrode-side coupling-point in the region of an electrode and a supply-side coupling-point of a supply-point of a welding appliance. The connection arrangement includes an electrical conductor, with a first terminally-arranged contact section for connection to the electrode-side coupling-point, and with a second contact section, arranged terminally in relation to the first contact section, for connection to the supply-side coupling-point. In accordance with the invention, the first contact section, with the electrode-side coupling-point, and the second contact section, with the supply-side coupling-point, are provided as socket/plug connections.

This means that in the connection arrangement according to the invention in each instance both coupling-points and the contact sections to be connected to the coupling-points are provided as socket/plug connections and can be plugged together along a plug-in axis.

By virtue of the design of both ends of the electrical conductor to be connected to the respective coupling-points, the advantage comes about that the connection is easier to establish. In addition, the transmission of current with respect to terminals or terminal-like elements has been improved, because terminals or terminal-like elements have an undefined electrical contact. In addition, the connection arrangement can be plugged together and separated again very easily, which is an advantage in the case of inspection work.

The electrode-side coupling-point may have been directly on the electrode or on an arm of the welding device on which the electrode was mounted. “Electrode-side” in connection with the present application is to be understood to the effect that the corresponding coupling-point leads to the electrode. The electrode-side coupling-point may be close to the electrode, to the welding arm—on which the electrode was mounted—or to a connection element leading to the welding arm.

The connection arrangement is preferably of unipolar design. That means the pairing comprising the electrode-side coupling-point, the supply-side coupling-point and the connection arrangement is unipolar. Two connection arrangements have then been arranged in one welding appliance.

The socket/plug connection is preferably a cylindrical connection, so that the electrical conductor is capable of swiveling relative to the coupling-points. By this means, any breaks in the electrical conductor can be counteracted.

The two contact sections have preferentially been designed in each instance to be substantially the same or even identical to one another. The same applies to the two coupling-points. By this means, the advantage comes about that the transmission of current from the supply-point to the electrical conductor and from the electrical conductor to the electrode has the same characteristic in each instance. The two contact sections may also be different, depending upon the installation situation.

The electrical conductor preferably takes the form of a flexible cable. The flexible cable preferably comes into operation when, in the course of mounting, the conditions require a little more flexibility. In addition, the flexible cable can very easily compensate for a movement between the supply side and the electrode side in the course of a welding. The flexible cable enables, moreover, a bridging of geometrical conditions, as a result of which elaborately manufactured contact pieces can be dispensed with. In this respect, by virtue of the design of the electrical conductor as a flexible cable a very efficient, in particular cost-effective, production of the electrical conductor can be obtained.

The electrical conductor preferentially has a cross-section of more than 200 mm². In particular, the cross-section is between 200 mm² and 5000 mm² or between 500 mm² and 800 mm².

At least one electrically conducting contact strip is preferentially arranged between the respective coupling-point and the corresponding contact section.

With the contact strip, a defined electrical contact can be provided.

By a “contact strip” in the present case, an electrically conducting contact element is understood that has the shape of a strip and comprises a multiplicity of spring-loaded contact parts. The contact parts can be provided by the strip itself, or have been attached to the strip as separate elements.

In a first variant, the contact sections of the electrical conductor preferably take the form of plug pins, and the coupling-points of the electrode or supply-point preferentially take the form of sockets.

In a second variant, the contact sections of the electrical conductor take the form of sockets, and the coupling-points of the electrode or supply-point take the form of plug pins.

The two stated variants have the advantage that no errors can occur in the course of plugging together.

In a third variant, one end of the electrical conductor takes the form of a plug pin, and the other end of the electrical conductor takes the form of a socket, the coupling-points correspondingly being designed likewise.

The plug pins are preferably oriented in the direction of the central axis of the electrical conductor. Alternatively, the plug pins are oriented inclined at an angle, in particular at a right angle or at 45°, relative to the central axis of the electrical conductor.

In the version inclined at an angle, the electrical conductor may have been provided with a further electrical contact element in the region of the bend-point. The electrical contact element may be, for instance, a plug-in connection.

A respective contact unit is preferentially arranged between the first contact section and the electrode-side coupling-point and between the second contact section and/or the supply-side coupling-point, with which an electrical contact in the socket/plug connection can be established.

The contact unit has the advantage that the contact between socket and plug pin can be further improved. In particular, the advantage comes about that the spatial circumstances can be optimally designed for the optimization of the electrical contact.

The contact unit preferably includes a contact body of electrically conducting design, a first contact strip and a second contact strip, said first contact strip establishing an electrical contact between the contact section and the contact body, and said second contact strip establishing an electrical contact between the contact body and the coupling-point. This means that the electrical contacting between coupling-point and contact section takes place via the first contact strip, the contact body and the second contact strip.

With respect to an advantageous design of a contact strip, reference is made to the above clarification.

The contact strips are preferably supported in recesses on the contact body. A support of such a type has the advantage that the socket and also the plug pins each have a substantially cylindrical surface, of constant diameter in each instance, simplifying their production. In addition, the respective diameters do not have to be manufactured wholly precisely, so even greater tolerances can be permitted. These tolerances can then be bridged by the contact strips. This means greater manufacturing tolerances can be chosen.

The two contact strips have preferably been have been arranged at least partially one above the other, viewed in cross-section at right angles to the plug-in axis.

This means the exterior contact strip is substantially situated in such a manner that it is situated in the same region as the interior contact strip. By this means, the transmission of current in the contact strip can be optimized.

A mechanical locking connection is preferably provided between the electrical conductor and the contact body. The electrical conductor can be locked relative to the contact body, so that the connection between the electrical conductor and the contact body cannot be separated unintentionally.

The locking connection preferably acts on the contact body and on the respective contact section of the electrical conductor. But the locking appliance may also take hold at other places on the electrical conductor.

The mechanical locking connection preferably blocks a movement between the electrical conductor and the contact body in the direction of the plug-in axis, and allows a rotational movement around the plug-in axis. By this means, the electrical conductor in the contact body can accordingly move so as to be capable of swiveling around the plug-in axis, in which connection an unplugging of the electrical conductor from the contact body is avoided at the same time.

The locking connection preferably acts on a portion of the electrical conductor or of the contact section that has a larger diameter than the contact sections.

The locking connection is preferably a bracket which is movably supported on the contact body in a receptacle, the mobility being at right angles to the plug-in axis and around a circumferential groove on the plug pin, said bracket engaging in the groove and being capable of being moved out of the groove.

The contact body preferably exhibits an interior space bounded by a side wall, said side wall providing a contact region of annular cross-section, said electrical conductor protruding with its contact section into the interior space, and the first contact strip being situated between the inside and the contact section in the interior space; and the second contact strip being situated on the outside and establishing an electrical contact with the socket.

In the plugged state the contact body is preferably situated substantially completely or at least partially in the interior space of the socket, the contact region of the contact body in this case being situated completely within the interior space of the socket.

The contact body preferentially exhibits on the outside a compression surface to which the contact body with the respective coupling-point is capable of being connected via a compression connection. This means that the contact body is pressed, for instance, into the socket and is held there by force closure and/or by positive closure. The compression bond is then established via the compression surface and the inside of the socket. By this means, electrical conductivity for transmission of current is ensured.

The interior space preferably exhibits, opposite an access opening through which the electrical conductor with the contact section protrudes into the interior space, a wall which closes off the interior space toward the rear. The wall preferably extends over the entire cross-section, so that the socket takes the form of a blind hole and is accessible substantially only via the access opening.

A seal is preferably arranged between the socket and the contact body, said seal being arranged in front of the contact strip, viewed in the plug-in direction. This means the seal is situated closer to the access opening, so that no water or moisture is able to reach the contact strip via the access opening. By this means, corrosive damage can be avoided, increasing the useful life overall.

In a further version, the electrode-side coupling-point and/or the supply-side coupling-point and/or the first contact section and/or the second contact section is/are provided with cooling ducts that are capable of being connected to cooling hoses. By this means, an efficient cooling can be provided in the region of the electrical contacting.

Said cooling duct is preferably provided with a duct inlet and a duct outlet, one of the cooling hoses being arranged in the region of the duct inlet, and another of the cooling hoses being arranged in the region of the duct outlet.

The cooling ducts have preferably been integrally molded on the plug pin and/or on the socket, said cooling ducts penetrating the plug pins or the socket at a point that is spaced from the electrical contact-point between the plug pin and the socket. The spacing between the electrical contact-point between pin and socket may be axial or radial relative to the socket.

But the cooling duct may also be part of a sleeve which peripherally surrounds the point to be cooled. The sleeve is an element formed separately from the plug pin and/or socket.

A welding device comprises an electrode with an electrode-side coupling-point, a supply-point with a supply-side coupling-point, and also at least one electrical connection arrangement according to the above description.

The welding device is preferentially a spot-welding device.

Further embodiments are specified in the dependent claims.

### BRIEF DESCRIPTION OF THE DRAWINGS

Preferred embodiments of the invention will be described in the following with reference to the drawings which serve merely for elucidation and are not to be interpreted as being restrictive. Shown in the drawings are:

FIG. 1 a perspectival view of a welding appliance;

FIG. 2 a sectional representation of an embodiment of an electrical connection appliance according to the invention;

FIG. 3 a perspectival exploded representation of an embodiment of an electrical connection appliance according to the invention;

FIG. 4 a further perspectival view of the electrical connection appliance according to FIGS. 2 to 3;

FIG. 5 a sectional detailed view of the electrical connection appliance according to FIGS. 2 to 4;

FIG. 6 a further sectional detailed view of the electrical connection appliance according to FIGS. 2 to 5;

FIG. 7 a further variant of the electrical connection appliance;

FIG. 8 a further variant of the electrical connection appliance;

FIG. 9 a perspectival exploded representation of the connection appliance according to the invention with additional cooling of the connection appliance;

FIG. 10 the connection appliance with additional cooling according to FIG. 9 in the connected state;

FIG. 11 a sectional representation through a first end region of the connection appliance with additional cooling; and

FIG. 12 a sectional representation through a second end region of the connection appliance with additional cooling.

### DESCRIPTION OF PREFERRED EMBODIMENTS

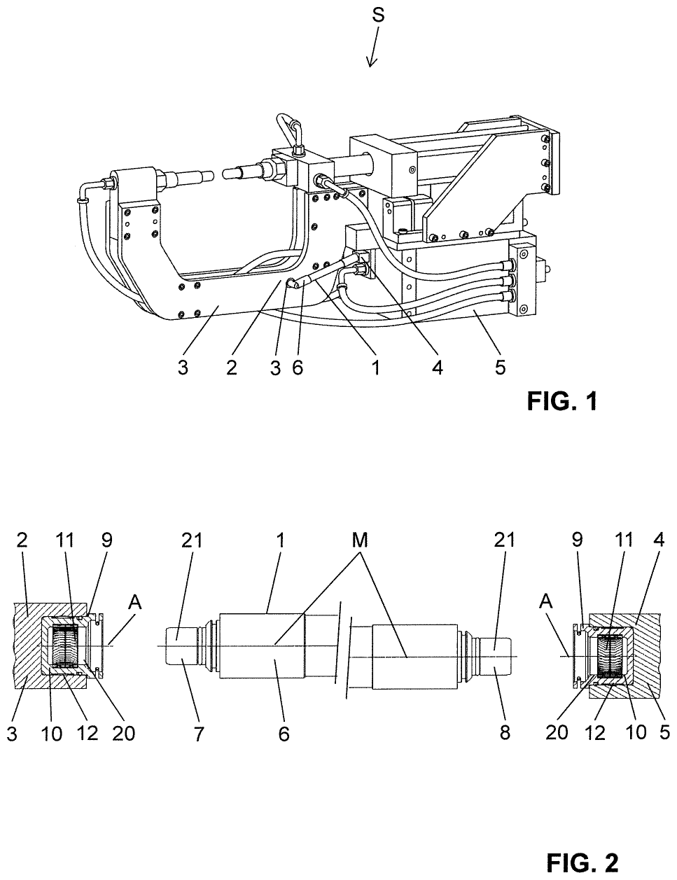

A welding device S is shown in FIG. 1. The welding device S includes an electrode 3 and a supply-point 5. The supply-point 5 supplies the electrode 3 with electrical energy. The welding device S according to FIG. 1 takes the form of C-type tongs. But the welding device S may also take the form of X-type tongs, or may have been designed in some other way.

An electrical connection arrangement 1 according to an embodiment of the present invention is arranged between the supply-point 5 and the electrode 3. The electrical connection arrangement 1 provides an electrical contact between the supply-point 5 and the electrode 3.

In the embodiment shown, the electrode 3 is a spot-welding device. But other welding devices may also be employed. The supply-point 5 may be a coupling of a transformer or of a similar supply element.

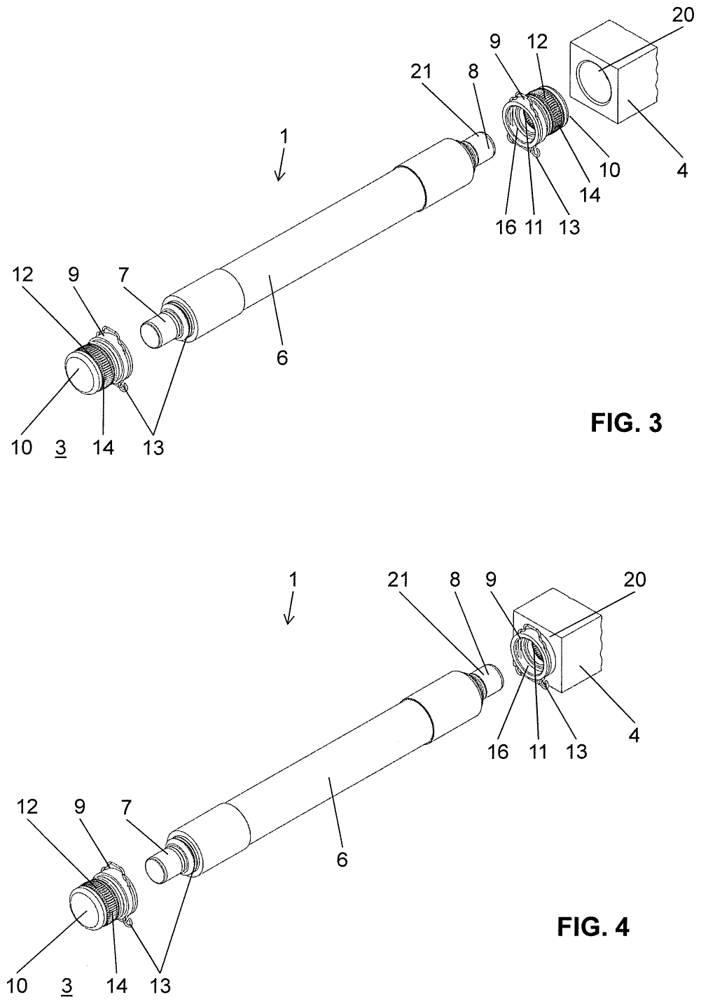

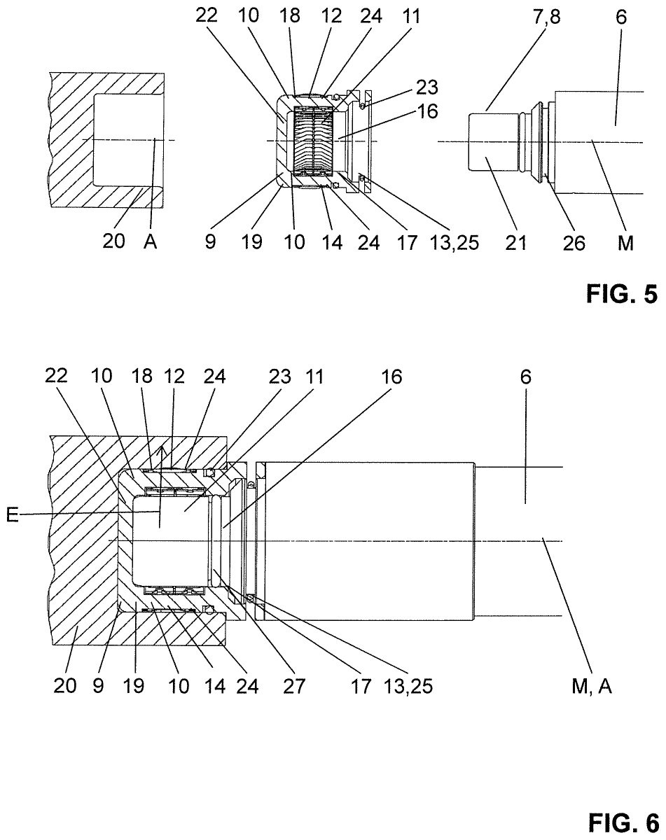

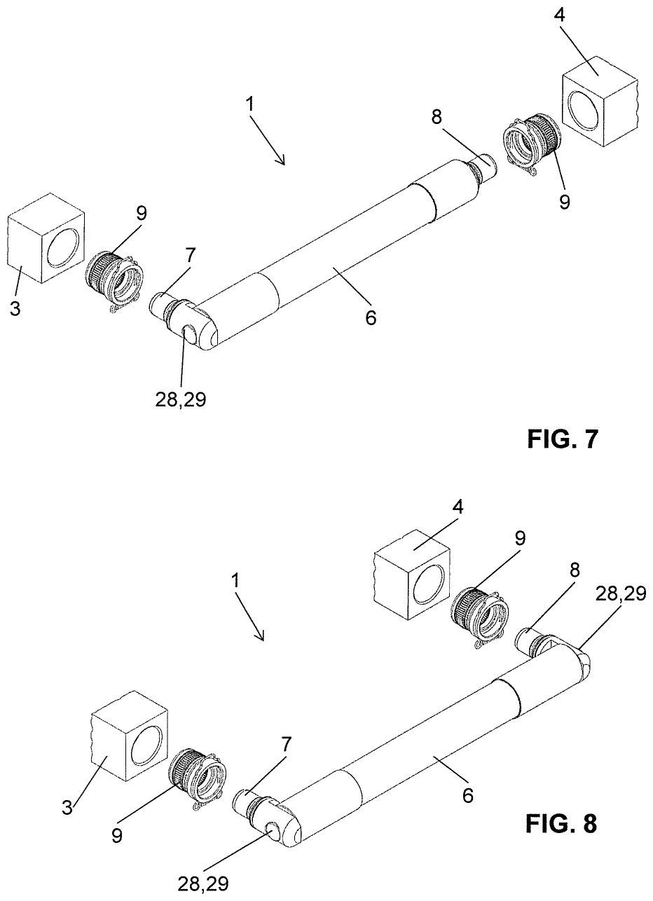

In the following, the electrical connection arrangement will now be explained in detailed manner with reference to FIGS. 2 to 8. FIGS. 2 to 6 show a first variant of the electrical connection arrangement 1; in FIG. 7 a second variant is shown; and in FIG. 8 a third variant is shown.

The electrical connection arrangement 1 may also be designated as a secondary-circuit welding connectors arrangement. For the sake of simplicity, in the following the electrical connection arrangement 1 will be designated as the connection arrangement 1. The connection arrangement 1 serves for switching an electrical contact between an electrode-side coupling-point 2 of the electrode 3 and a supply-side coupling-point 4 of a supply-point 5 of the welding appliance S.

The connection arrangement 1 comprises an electrical conductor 6 with a first terminally-arranged contact section 7, for connection to the electrode-side coupling-point 2, and with a second terminally-arranged contact section 8 opposite the first contact section 7, for connection to the supply-side coupling-point 4. Both coupling-points 2, 4 and both contact sections 7, 8 take the form of socket/plug connections 20, 21 and can be plugged together along a plug-in axis A. This means contact section 7 with coupling-point 2 has been designed as a socket/plug connection 20. Furthermore, the connection between the second contact section 8 and the supply-side coupling-point 4 likewise takes the form of a socket/plug connection 21. This means the respective contact sections 7, 8 can be connected to one another to the respective coupling-points 2, 4 via a plug-in connection.

This arrangement has the advantage that the connection arrangement 1 is easily interchangeable, and a defined electrical contact between the supply-point 5 and the electrode 3 can be established.

The electrical conductor 6 preferentially takes the form of a flexible cable. The cable may exhibit several twisted stranded wires. Terminally the flexible cable exhibits, in each instance, the corresponding contact section 7, 8 for the electrical connection to the corresponding coupling-point 2, 4. The contact section 7, 8 is preferentially connected to the cable via a crimp connection. The electrical conductor 6 preferentially has a cross-section of more than 200 mm². In particular, the cross-section is between 200 mm² and 5000 mm² or between 600 mm² and 800 mm².

With respect to mounting, it is advantageous firstly to bend the cable slightly and subsequently to mount the contact sections 7, 8.

A contact strip 11, 12 has preferably been arranged in each instance between the coupling-points 2, 4 and the contact sections 7, 8. With the contact strip 11, 12, an electrical contact between the coupling-point 2, 4 and the corresponding contact section 7, 8 can be established. The contact strip 11, 12 has been designed to be electrically conducting and may also be designated as a contact lamella.

In the embodiment shown, the contact sections 7, 8 of the electrical conductor 1 take the form of plug pins 21, and the coupling-points 2, 4 of the electrode 3 and of the supply-point 5 take the form of sockets 20. The plug pins 21 are plugged into the sockets 20 along said plug-in axis A. A different configuration is likewise conceivable. For instance, the contact sections 7, 8 of the electrical conductor 6 may also take the form of sockets 20, and the coupling-points 2, 4 may also take the form of plug pins 21. In addition, it would also be conceivable that one of the contact sections 7, 8 takes the form of a plug pin 21, and the other takes the form of a socket 20.

In the variant according to FIGS. 2 to 6, the plug pins 21 are oriented substantially in the direction of the central axis M of the electrical conductor 6. Accordingly, a straight electrical conductor 6 is substantially provided. In the embodiments shown in FIGS. 7 and 8, the plug pins 21 are inclined at an angle, here at a right angle, to the central axis M of the electrical conductor 6. It is also conceivable that the plug pins 21 are at an angle of, for instance, 45° to the central axis M. Other angles between 0° and less than 180° are likewise conceivable. Which of the stated embodiments is effectively employed is determined substantially by the installation situation.

In the version inclined at an angle, the electrical conductor may have been provided with a further electrical contact element 29 in the region of the bend-point 28. The electrical contact element 29 may be, for instance, a plug-in connection, said plug-in connection being arranged terminally on the electrical conductor 6 and electrically connected to the respective contact sections 7, 8.

In the embodiments shown pertaining to FIGS. 1 to 8, a contact unit 9 has been arranged in each case between the first contact section 7 and the electrode-side coupling-point 2 and also between the second contact section 8 and the supply-side coupling-point 4. With the contact unit 9, the electrical contact in the socket/plug connection 20, 21 can be established. The electrical contact between the first contact section 7 and the electrode-side coupling-point 2 and also between the second contact section 8 and the supply-side coupling-point 4 is established via the contact unit 9.

The contact unit 9 substantially has the advantage that a defined electrical contact in the socket/plug connection 20, 21 can be established. This can be an advantage particularly in the case of the retrofitting of welding devices, when the socket should have been closed. But the contact unit 9 is an advantage even in new welding devices, because a defined and consequently plannable or easily dimensioned electrical contact can be established substantially independently of the surface condition of the socket 20. In particular, a plug-in connection with a defined contact resistance can be provided.

In addition, the contact unit 9—that is to say, the cable 6 with the two contact sections 7, 8—can be interchanged upon attaining its life duration, without major conversions having to be effected in respect of the supply-side coupling-point 4.

In addition, the socket/plug connection 20, 21 permits a swiveling movement between the socket and the plug, this being an advantage in the course of movement of the welding device.

In the embodiment shown, the contact unit 9 comprises a contact body 10 of electrically conducting design, a first contact strip 11 and a second contact strip 12.

The first contact strip 11 provides an electrical contact between the contact sections 7, 8 and the contact body 10. The second contact strip 12 establishes an electrical contact between the contact body 10 and the coupling-point 2, 4. In FIGS. 2 to 5, the configuration in the unplugged state is shown, and the configuration in the plugged state is shown in FIG. 6. From FIG. 6 it can be readily discerned that the electrical path between the socket 20 and the plug pin 21 leads from the outside via the second contact strip 12, then via the contact body 10, and finally via the first contact strip 11. The electrical path has been sketched in FIG. 6 by the arrow E.

The contact body 10 exhibits a contact region 14 of annular cross-section and an interior space 16 bounded by a side wall 15. The electric current will flow substantially over the contact region 14.

The electrical conductor 6 protrudes with its contact section 7, 8 into the interior space 16, and the first contact strip 11 is situated between the inside 17 of the interior space 16 and the contact section 7, 8 in the interior space 16.

The second contact strip 12 rests on the outside 18 of the side wall 15 and establishes the electrical contact between the contact region 14 and the socket 20. The contact body 10 protrudes into the socket 20 and is substantially completely received by the socket 20.

In the embodiment shown, the contact body 10 exhibits on the outside a compression surface 19 with which the contact body 10 is capable of being connected into the respective coupling-point 2 via a compression connection. In the embodiment shown, the compression surface 19 is provided by the outside 18.

The compression connection is preferentially established by a pressing force of 2000-2500 newtons.

The two contact strips 11, 12 are supported in recesses 24 in the form shown. The recesses 24 extend into the contact region 14. Here the recesses 24 extend into the side wall 15 from the inside 17 and from the outside 18.

The interior space 16 of the contact body 10 exhibits a wall 22 opposite an access opening 20 through which the respective contact section 7, 8 of the electrical conductor 6 protrudes into the interior space 16. The wall 22 closes off the interior space 16 toward the rear. Consequently the interior space 16 is accessible exclusively via the access opening 20.

The wall 22 may have been integrally molded on the contact body 10. In another variant it would also be conceivable to design the wall 22 as a wall that is capable of being inserted into the interior space 16.

For instance, the wall might have been formed by a screw cap which can be inserted into the interior space 16 from a front side.

Between the socket 20 and the contact body 10 a seal 23 has been arranged in addition. Viewed in the plug-in direction, the seal 23 is arranged in front of contact strip 12, as a result of which the entire interior space 16, in particular contact strip 12, is protected against the ingress of moisture into the socket.

A further seal 27 is arranged in the region of the respective contact section 7, 8. Seal 27 seals off the gap between the inside 17 and the respective contact section 7, 8.

Moreover, a mechanical locking connection 13 is provided between the electrical conductor 6 or the respective contact sections 7, 8 and the contact body 10. The mechanical locking connection 13 has been configured in such a manner that a movement between the electrical conductor 6 and the contact body 10 in the direction of the plug-in axis A is blocked, but a rotational movement around the plug-in axis A is allowed. In the embodiment shown, the locking connection 13 is on a portion of the contact section 7, 8 and is in communication with the contact body 10. In the embodiment shown, it is a question of a locking bracket 25 which engages in a circumferential groove 26 on the respective contact section 7, 8.

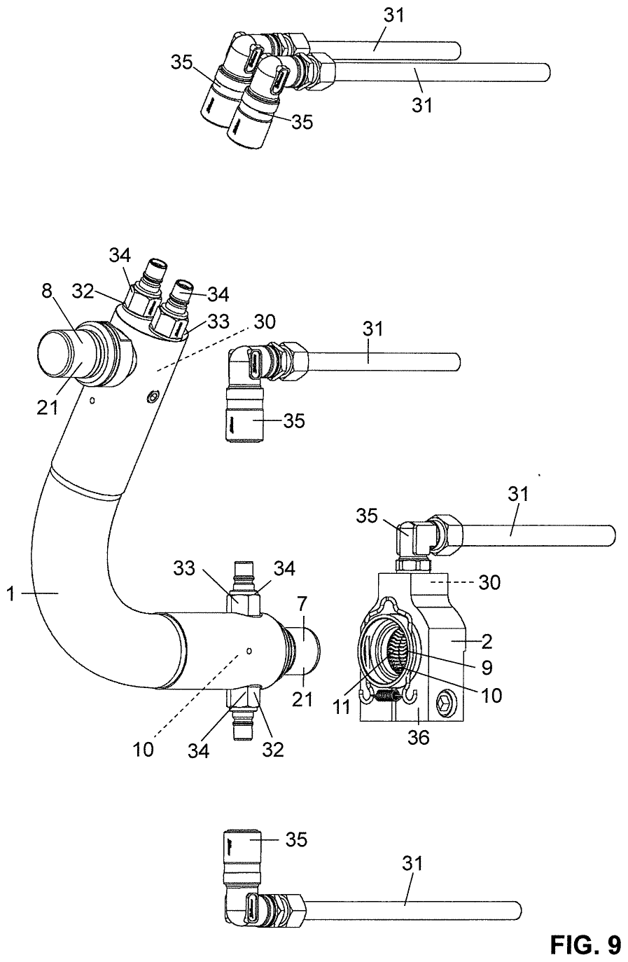

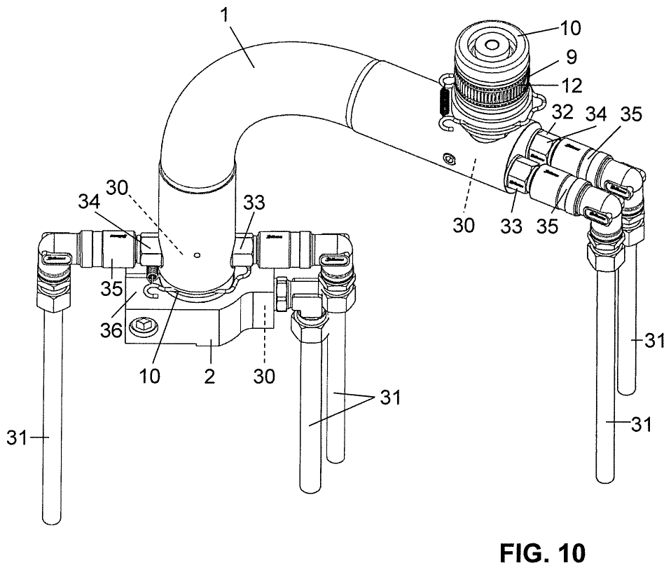

In FIGS. 9 to 12 a further embodiment of the electrical connection arrangement 1 is shown. Like parts have been provided with the same reference numerals. In addition to the features described above, the connection arrangement 1 includes a cooling system. In the version shown, the electrode-side coupling-point 2, the supply-side coupling-point 3, the first contact section 7 and the second contact section 8 have been provided with cooling ducts 30. A coolant is capable of being circulated through these cooling ducts 30, so that the respective parts can be cooled. The cooling ducts here are in communication with cooling hoses 31 via which the coolant can be supplied to the respective parts and conducted away again. The cooling hoses 31 are preferably in communication with a coolant pump, not shown, which circulates the coolant in the cooling ducts 30.

The cooling ducts can be provided, for instance, by virtue of appropriate bores in the respective elements.

Each of the cooling ducts 30 exhibits a duct inlet 32 and a duct outlet 33. The duct inlet 32 and the duct outlet 33 is in communication with the cooling hose 31. Here, fittings 34 have been screwed into the duct inlet and into the duct outlet 33. The fittings 34 are then capable of being connected via corresponding fittings 35 which are terminally arranged on the cooling hose.

From FIGS. 9 to 12 it is shown that the cooling ducts 30 penetrate the plug pins 21 and the socket 20 at a point that is spaced from the electrical contact-point between the plug pin 21 and the socket 20. By “spaced”, a radial or an axial spacing is understood. The electrical contact-point in the embodiment shown is where the contact unit 9 is situated.

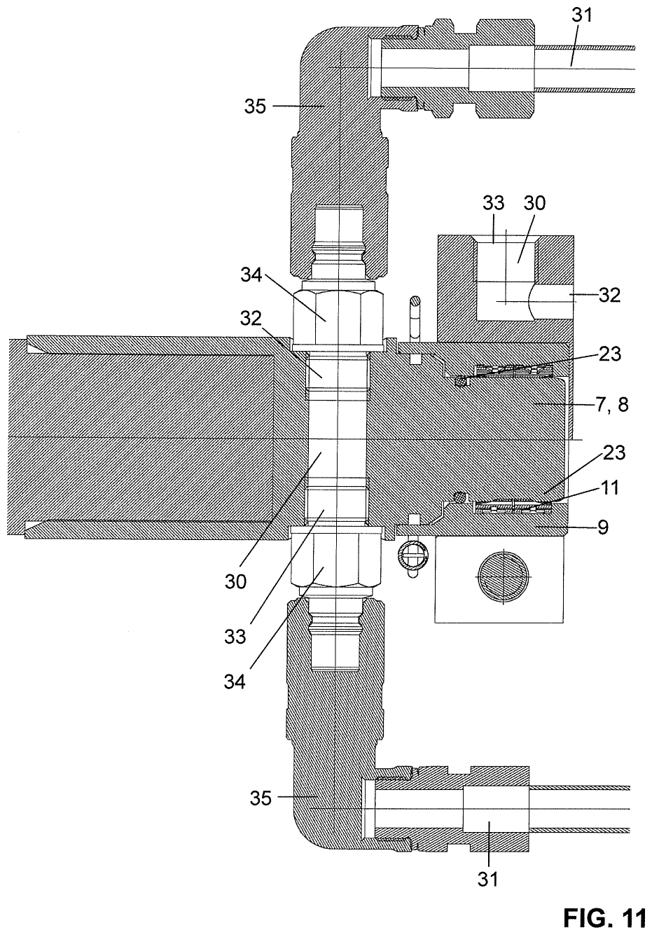

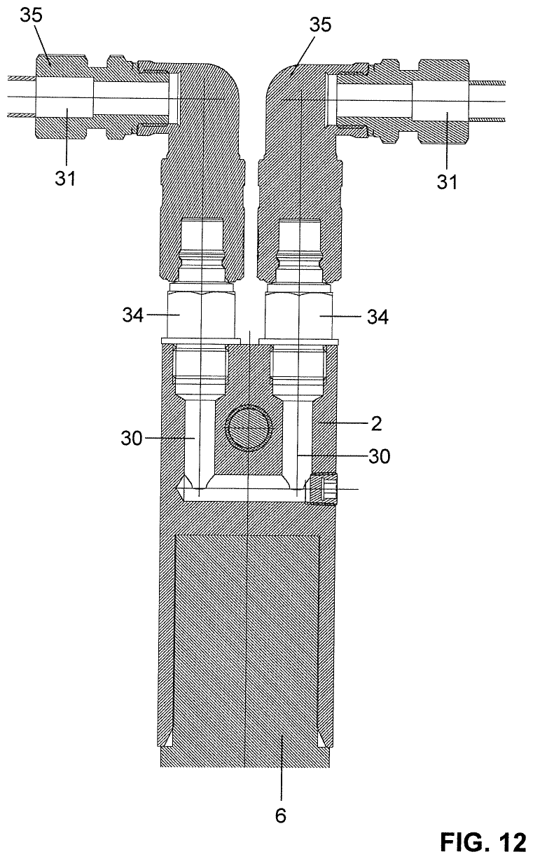

With respect to the plug pin 21, this means that the cooling ducts 30 are situated between the contact unit 8 and the connection-point between the plug pin 21 and the electrical conductor 6. With respect to the socket 20, this means that the cooling ducts 30 are situated, for instance, radially on the outside relative to the contact unit 8 or frontally relative to the contact unit 8. The exterior arrangement is shown in FIG. 11, and the frontal arrangement is shown in FIG. 12.

This means the cooling ducts are preferably situated between the contact unit 9 and the contact-point between the electrical conductor 6.

In a further design, however, the cooling ducts may be part of a sleeve 36 which circumferentially surrounds the socket or the plug pin. The sleeve 36 is shown here, by way of example, on the socket 20.

### LIST OF REFERENCE SYMBOLS

1 electrical connection arrangement
2 electrode-side coupling-point
3 electrode
4 supply-side coupling-point
5 supply-point
6 electrical conductor
7 first contact section
8 second contact section
9 contact unit
10 contact body
11 first contact strip
12 second contact strip
13 latching connection
14 contact region
15 side wall
16 interior space
17 inside
18 outside
19 compression surface
20 socket
21 plug pins
22 wall
23 seal
24 recesses
25 locking bracket
26 groove
27 seal
28 kink-point
29 electrical contact element
30 cooling duct
31 cooling hose
32 duct inlet
33 duct outlet
34 fitting
35 fitting
36 sleeve
A plug-in axis
E electrical path
S welding device
M central axis

1-18. (canceled)

19. An electrical connection arrangement for establishing an electrical contact between an electrode-side coupling-point, in the region of an electrode, and a supply-side coupling-point of a supply-point of a welding appliance,
wherein the connection arrangement comprises an electrical conductor with a first terminally arranged contact section, for connection to the electrode-side coupling-point, and with a second terminally arranged contact section opposite the first contact section, for connection to the supply-side coupling-point, and
wherein the first contact section, with the electrode-side coupling-point, and the second contact section, with the supply-side coupling-point, are formed as a socket/plug connection and can be plugged together along a plug-in axis.

20. The electrical connection arrangement as claimed in claim 19, wherein the electrical conductor takes the form of a flexible cable.

21. The electrical connection arrangement as claimed in claim 19, wherein the electrical conductor has a cross-section of more than 200 mm².

22. The electrical connection arrangement as claimed in claim 19, wherein at least one electrically conducting contact strip is arranged between the respective coupling-point and the corresponding contact section.

23. The electrical connection arrangement as claimed in claim 19, wherein the contact sections of the electrical conductor take the form of plug pins, and wherein the coupling-points of the electrode or supply-point take the form of sockets.

24. The electrical connection arrangement as claimed in claim 19,
wherein the contact sections of the electrical conductor take the form of plug pins, and wherein the coupling-points of the electrode or supply-point take the form of sockets, and
wherein the plug pins are oriented in the direction of the central axis of the electrical conductor; or wherein the plug pins are inclined at an angle, in particular at a right angle or at 45°, to the central axis of the electrical conductor.

25. The electrical connection arrangement as claimed in claim 19, wherein the contact sections of the electrical conductor take the form of sockets, and wherein the coupling-points of the electrode or supply-point take the form of plug pins.

26. The electrical connection arrangement as claimed in claim 19,
wherein the contact sections of the electrical conductor take the form of sockets, and wherein the coupling-points of the electrode or supply-point take the form of plug pins, and
wherein the plug pins are oriented in the direction of the central axis of the electrical conductor; or wherein the plug pins are inclined at an angle, in particular at a right angle or at 45°, to the central axis of the electrical conductor.

27. The electrical connection arrangement as claimed in claim 19, wherein between the first contact section and the electrode-side coupling-point and/or between the second contact section and the supply-side coupling-point a contact unit is arranged in each instance, with which an electrical contact in the socket/plug connection can be established.

28. The electrical connection arrangement as claimed in claim 27, wherein the contact unit comprises a contact body of electrically conducting design, a first contact strip and a second contact strip, said first contact strip establishing an electrical contact between the contact section and the contact body, and said second contact strip establishing an electrical contact between the contact body and the coupling-point.

29. The electrical connection arrangement as claimed in claim 27, wherein the contact strips are supported in recesses on the contact body; and/or wherein the two contact strips are arranged at least partially one above the other, viewed in cross-section at right angles to the plug-in axis.

30. The electrical connection arrangement as claimed in claim 27, wherein a mechanical locking connection is provided between the electrical conductor and the contact body.

31. The electrical connection arrangement as claimed in claim 30,
wherein the mechanical locking connection blocks a movement between the electrical conductor and the contact body in the direction of the plug-in axis and allows a rotational movement around the plug-in axis, and/or
wherein the locking connection acts on a portion of the electrical conductor or of the contact section that has a larger diameter than the contact sections.

32. The electrical connection arrangement as claimed in claim 27,
wherein the contact body exhibits an interior space bounded by a side wall, wherein the side wall exhibits a contact region, and wherein the electrical conductor with its contact section protrudes into the interior space, and the first contact strip is situated between the inside and the contact section in the interior space, and
wherein the second contact strip is situated on the outside and establishes an electrical contact with the socket.

33. The electrical connection arrangement as claimed in claim 32, wherein the contact body exhibits on the outside a compression surface with which the contact body is capable of being connected to the respective coupling-point via a compression connection.

34. The electrical connection arrangement as claimed in claim 32, wherein the interior space exhibits, opposite an access opening through which the contact sections of the electrical conductor protrudes into the interior space, a wall which closes off the interior space toward the rear.

35. The electrical connection arrangement as claimed in claim 30, wherein a seal is arranged between the socket and the contact body, said seal being arranged in front of contact strip.

36. The electrical connection arrangement as claimed in claim 19, wherein the electrode-side coupling-point and/or the supply-side coupling-point and/or the first contact section and/or the second contact section is/are provided with cooling ducts that are capable of being connected to cooling hoses.

37. The electrical connection arrangement as claimed in claim 36, wherein said cooling duct is provided with a duct inlet and with a duct outlet, one of the cooling hose being arranged in the region of the duct inlet, and another of the cooling hoses being arranged in the region of the duct outlet.

38. The electrical connection arrangement as claimed in claim 36, wherein the cooling ducts are arranged integrally on the plug pin and on the socket and penetrate the plug pin and the socket at a point that is spaced from the electrical contact-point between the plug pin and the socket.

39. The electrical connection arrangement as claimed in claim 36, wherein the cooling duct is part of a sleeve which peripherally surrounds the point to be cooled.

40. The electrical connection arrangement as claimed in claim 19, wherein the electrical connection arrangement is a secondary-circuit welding connector arrangement.

41. A welding device comprising an electrode with an electrode-side coupling-point, a supply-point with a supply-side coupling-point, and also at least one electrical connection arrangement as claimed in claim 19.
